(19) United States
(12) Patent Application Publication
(10) Pub. No.: US 2026/0270017 A1
(43) Pub. Date: Sep. 10, 2026

(54) SUPPORT OF LAYER 1 AND LAYER 2 TRIGGERED MOBILITY

(71) Applicant: LENOVO (BEIJING) LIMITED, Beijing (CN)

(72) Inventors: Bingchao Liu, Beijing (CN); Chenxi Zhu, Beijing (CN)

(21) Appl. No.: 19/166,115

(22) PCT Filed: Jul. 14, 2023
(86) PCT No.: PCT/CN2023/107482

§ 371 Date: Sep. 17, 2025

(51) Int. Cl. H04L 5/00; H04W 24/10; H04W 72/231

(52) U.S. Cl. CPC H04L 5/0053; H04W 24/10; H04W 72/231

(57) ABSTRACT

Various aspects of the present disclosure relate to methods, apparatuses, and systems that support LTM. Some implementations of the method and apparatuses described herein may further include a user equipment (UE) for wireless communication, comprising: at least one memory; and at least one processor coupled with the at least one memory and configured to cause the UE to: receive a TCI states configuration of each of one or multiple candidate cells, wherein, the TCI states configuration includes multiple TCI states, and each TCI state provides two different QCL types.

### TECHNICAL FIELD

The present disclosure relates to wireless communications, and more specifically to layer 1 (L1) and layer 2 (L2) triggered mobility.

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Different from layer 3 (L3) based mobility, L1 measurements based on Channel State Information (CSI) reporting framework are used for L1/L2 triggered mobility (LTM). It means that the User Equipment (UE) can be configured to measure the qualities of different candidate cells in layer 1 and report the measurement results of the candidate cells to the serving cell in one or more CSI reports. If the UE reports that one of the candidate cells is better than the current serving cell, the gNB may indicate a cell switch command by a MAC CE to the UE to indicate the UE to switch from the current serving cell (i.e., source cell) to the candidate cell (i.e., target cell).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that support LTM.

Some implementations of the method and apparatuses described herein may further include a user equipment (UE) for wireless communication, comprising: at least one memory; and at least one processor coupled with the at least one memory and configured to cause the UE to: receive a TCI states configuration of each of one or multiple candidate cells, wherein, the TCI states configuration includes multiple TCI states, and each TCI state provides two different QCL types.

In some implementations of the method and apparatuses described herein, each TCI state includes a QCL-type A SSB and the same SSB with QCL-type D. Alternatively, each TCI state includes a QCL-type C SSB and the same SSB with QCL-type D. Further alternatively, each TCI state includes a QCL-type A TRS and the same TRS with QCL-type D and the TRS is further QCLed with a SSB from the same candidate cell.

Some implementations of the method and apparatuses described herein may include a processor in a UE for wireless communication, comprising: at least one controller coupled with at least one memory and configured to cause the processor to: receive a TCI states configuration of each of one or multiple candidate cells, wherein, the TCI states configuration includes multiple TCI states, and each TCI state provides two different QCL types.

Some implementations of the method and apparatuses described herein may include a method performed by a user equipment (UE), the method comprising: receiving a TCI states configuration of each of one or multiple candidate cells, wherein, the TCI states configuration includes multiple TCI states, and each TCI state provides two different QCL types.

Some implementations of the method and apparatuses described herein may include at least one memory; and at least one processor coupled with the at least one memory and configured to cause the base station to: transmit a TCI states configuration of each of one or multiple candidate cells, wherein, the TCI states configuration includes multiple TCI states, and each TCI state provides two different QCL types.

### BRIEF DESCRIPTION OF THE DRAWINGS

FIG. 1 illustrates an example of a wireless communications system in accordance with aspects of the present disclosure.

FIG. 2 illustrates an example of a user equipment (UE) 200 in accordance with aspects of the present disclosure.

FIG. 3 illustrates an example of a processor 300 in accordance with aspects of the present disclosure.

FIG. 4 illustrates an example of a network equipment (NE) 400 in accordance with aspects of the present disclosure.

FIG. 5 illustrates an example of the LTM timing.

FIG. 6 illustrates a flowchart of method performed by a UE in accordance with aspects of the present disclosure.

FIG. 7 illustrates a flowchart of method performed by a NE in accordance with aspects of the present disclosure.

FIG. 8 illustrates a flowchart of method performed by a UE in accordance with aspects of the present disclosure.

FIG. 9 illustrates a flowchart of method performed by a NE in accordance with aspects of the present disclosure.

FIG. 10 illustrates a flowchart of method performed by a UE in accordance with aspects of the present disclosure.

FIG. 11 illustrates a flowchart of method performed by a NE in accordance with aspects of the present disclosure.

FIG. 12 illustrates a flowchart of method performed by a UE in accordance with aspects of the present disclosure.

FIG. 13 illustrates a flowchart of method performed by a NE in accordance with aspects of the present disclosure.

### DETAILED DESCRIPTION

Aspects of the present disclosure are described in the context of a wireless communications system.

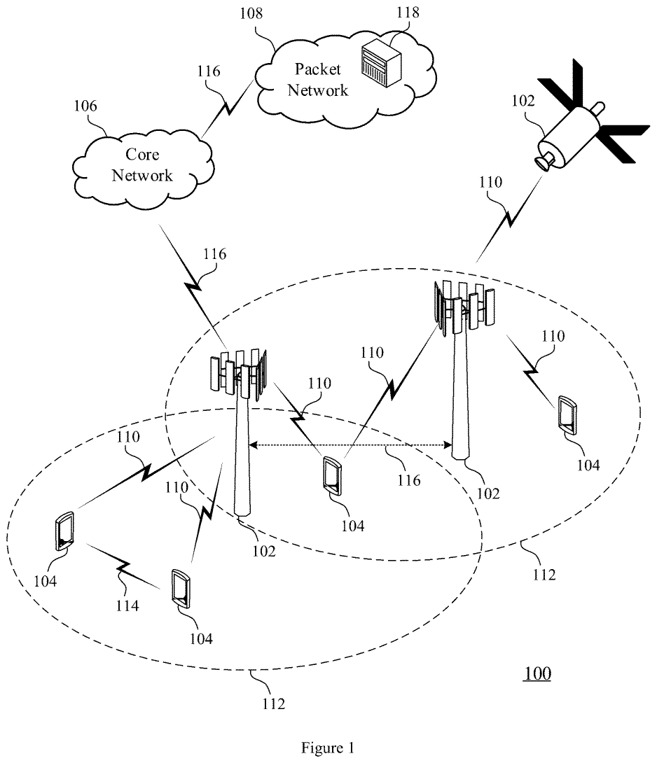

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE (Long Term Evoluation) network or an LTE-Advanced (LTE-A) network. In some other implementations, the wireless communications system 100 may be a New Radio (NR) network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link 110, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links 116 (e.g., S1, N2, N2, or network interface). The network entities 102 may communicate with each other over the backhaul links 116 (e.g., via an X2, Xn, or another network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network 108 over one or more backhaul links (e.g., via an S1, N2, N2, or another network interface). The packet data network 108 may include an application server 118. In some implementations, one or more UEs 104 may communicate with the application server 118. A UE 104 may establish a session (e.g., a protocol data unit (PDU) session, or the like) with the CN 106 via an NE 102. The CN 106 may route traffic (e.g., control information, data, and the like) between the UE 104 and the application server 118 using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHZ-24.25 GHz), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

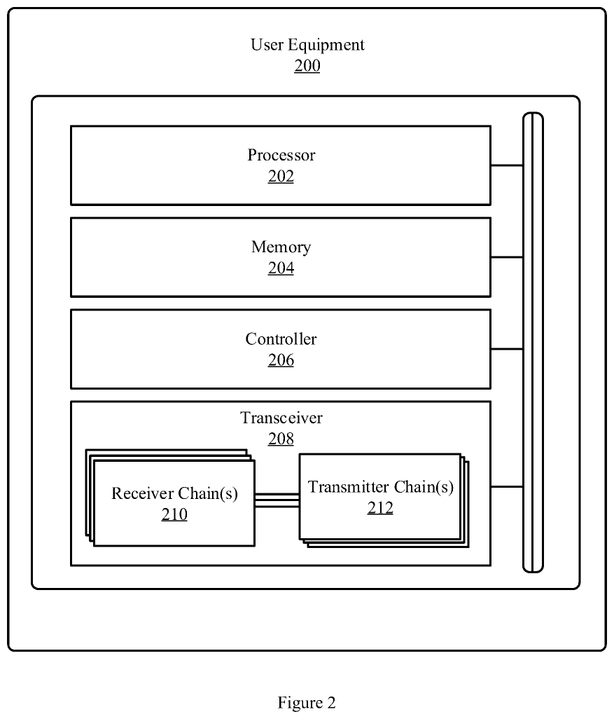

FIG. 2 illustrates an example of a UE 200 in accordance with aspects of the present disclosure. The UE 200 may include a processor 202, a memory 204, a controller 206, and a transceiver 208. The processor 202, the memory 204, the controller 206, or the transceiver 208, or various combinations thereof or various components thereof may be examples of means for performing various aspects of the present disclosure as described herein. These components may be coupled (e.g., operatively, communicatively, functionally, electronically, electrically) via one or more interfaces.

The processor 202, the memory 204, the controller 206, or the transceiver 208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 202 may include an intelligent hardware device (e.g., a general-purpose processor, a DSP, a CPU, an ASIC, an FPGA, or any combination thereof). In some implementations, the processor 202 may be configured to operate the memory 204. In some other implementations, the memory 204 may be integrated into the processor 202. The processor 202 may be configured to execute computer-readable instructions stored in the memory 204 to cause the UE 200 to perform various functions of the present disclosure.

The memory 204 may include volatile or non-volatile memory. The memory 204 may store computer-readable, computer-executable code including instructions when executed by the processor 202 cause the UE 200 to perform various functions described herein. The code may be stored in a non-transitory computer-readable medium such the memory 204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 202 and the memory 204 coupled with the processor 202 may be configured to cause the UE 200 to perform one or more of the functions described herein (e.g., executing, by the processor 202, instructions stored in the memory 204). For example, the processor 202 may support wireless communication at the UE 200 in accordance with examples as disclosed herein. The UE 200 may be configured to support a means for determining that a Physical Uplink Shared Channel (PUSCH) transmission is associated with a plurality of Phase-Tracking Reference Signal (PTRS) ports; and transmitting the PUSCH transmission together with the plurality of PTRS ports.

The controller 206 may manage input and output signals for the UE 200. The controller 206 may also manage peripherals not integrated into the UE 200. In some implementations, the controller 206 may utilize an operating system such as iOS®, ANDROID®, WINDOWS®, or other operating systems. In some implementations, the controller 206 may be implemented as part of the processor 202.

In some implementations, the UE 200 may include at least one transceiver 208. In some other implementations, the UE 200 may have more than one transceiver 208. The transceiver 208 may represent a wireless transceiver. The transceiver 208 may include one or more receiver chains 210, one or more transmitter chains 212, or a combination thereof.

A receiver chain 210 may be configured to receive signals (e.g., control information, data, packets) over a wireless medium. For example, the receiver chain 210 may include one or more antennas for receive the signal over the air or wireless medium. The receiver chain 210 may include at least one amplifier (e.g., a low-noise amplifier (LNA)) configured to amplify the received signal. The receiver chain 210 may include at least one demodulator configured to demodulate the receive signal and obtain the transmitted data by reversing the modulation technique applied during transmission of the signal. The receiver chain 210 may include at least one decoder for decoding the processing the demodulated signal to receive the transmitted data.

A transmitter chain 212 may be configured to generate and transmit signals (e.g., control information, data, packets). The transmitter chain 212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 212 may also include at least one power amplifier configured to amplify the modulated signal to an appropriate power level suitable for transmission over the wireless medium. The transmitter chain 212 may also include one or more antennas for transmitting the amplified signal into the air or wireless medium.

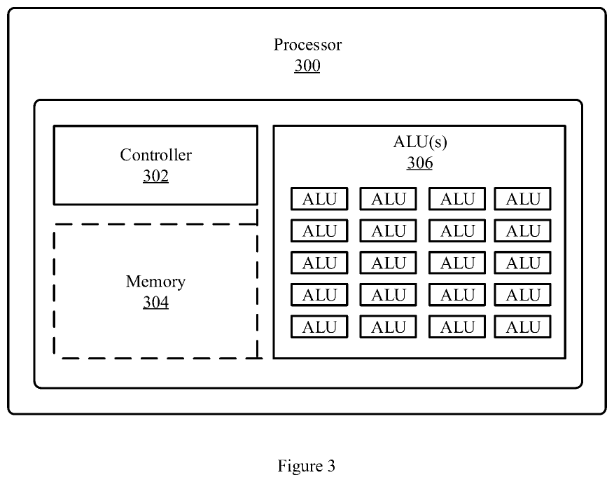

FIG. 3 illustrates an example of a processor 300 in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, which may be, for example, an L1/L2/L3 cache. Additionally, or alternatively, the processor 300 may optionally include one or more arithmetic-logic units (ALUs) 306. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory address of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein. Additionally, or alternatively, the controller 302 may be configured to manage flow of data within the processor 300. The controller 302 may be configured to control transfer of data between registers, arithmetic logic units (ALUs), and other functional units of the processor 300.

The memory 304 may include one or more caches (e.g., memory local to or included in the processor 300 or other memory, such RAM, ROM, DRAM, SDRAM, SRAM, MRAM, flash memory, etc. In some implementations, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, the processor 300, the controller 302, and the memory 304 may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 306 may be configured to support various operations in accordance with examples as described herein. In some implementations, the one or more ALUs 306 may reside within or on a processor chipset (e.g., the processor 300). In some other implementations, the one or more ALUs 306 may reside external to the processor chipset (e.g., the processor 300). One or more ALUs 306 may perform one or more computations such as addition, subtraction, multiplication, and division on data. For example, one or more ALUs 306 may receive input operands and an operation code, which determines an operation to be executed. One or more ALUs 306 be configured with a variety of logical and arithmetic circuits, including adders, subtractors, shifters, and logic gates, to process and manipulate the data according to the operation. Additionally, or alternatively, the one or more ALUs 306 may support logical operations such as AND, OR, exclusive-OR (XOR), not-OR (NOR), and not-AND (NAND), enabling the one or more ALUs 306 to handle conditional operations, comparisons, and bitwise operations.

The processor 300 may support wireless communication in accordance with examples as disclosed herein. The processor 300 may be configured to or operable to support a means for determining that a Physical Uplink Shared Channel (PUSCH) transmission is associated with a plurality of Phase-Tracking Reference Signal (PTRS) ports; and transmitting the PUSCH transmission together with the plurality of PTRS ports.

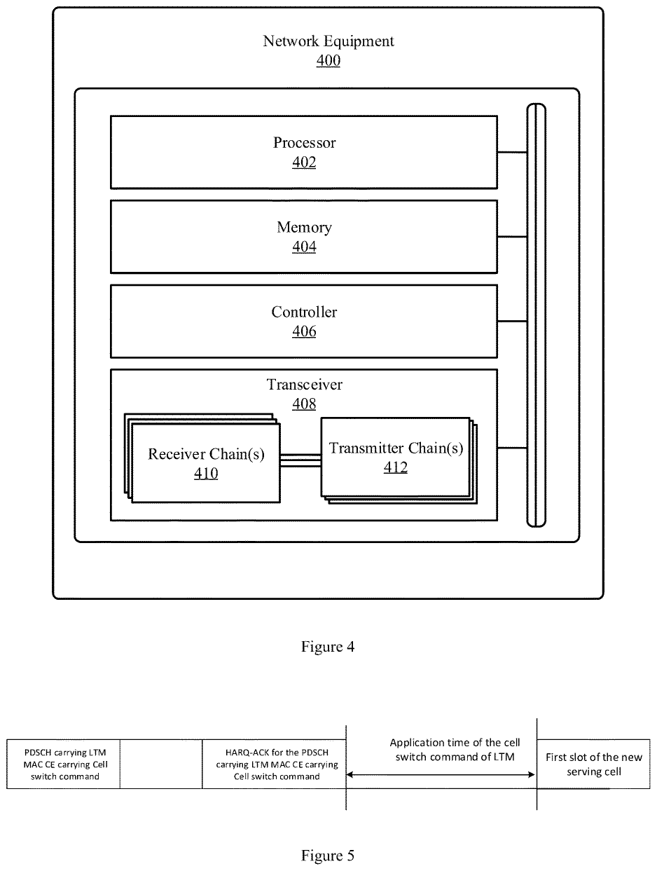

FIG. 4 illustrates an example of a NE 400 in accordance with aspects of the present disclosure. The NE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the NE 400 to perform various functions of the present disclosure.

The memory 404 may include volatile or non-volatile memory. The memory 404 may store computer-readable, computer-executable code including instructions when executed by the processor 402 cause the NE 400 to perform various functions described herein. The code may be stored in a non-transitory computer-readable medium such the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the NE 400 to perform one or more of the functions described herein (e.g., executing, by the processor 402, instructions stored in the memory 404). For example, the processor 402 may support wireless communication at the NE 400 in accordance with examples as disclosed herein. The NE 400 may be configured to support a means for determining that a Physical Uplink Shared Channel (PUSCH) transmission is associated with a plurality of Phase-Tracking Reference Signal (PTRS) ports; and receiving the PUSCH transmission together with the plurality of PTRS ports.

The controller 406 may manage input and output signals for the NE 400. The controller 406 may also manage peripherals not integrated into the NE 400. In some implementations, the controller 406 may utilize an operating system such as iOS®, ANDROID®, WINDOWS®, or other operating systems. In some implementations, the controller 406 may be implemented as part of the processor 402.

In some implementations, the NE 400 may include at least one transceiver 408. In some other implementations, the NE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas for receive the signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the processing the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

Before describing the application, an introduction of Transmission Configuration Indicator (TCI) state and unified TCI framework is provided.

In NR Release 17, DCI (Downlink Control Information) based unified TCI framework is supported. When joint DL/UL TCI (which means DL (downlink) RX (receiver) spatial filter and UL (uplink) TX (transmitter) spatial filter are determined by a same indicated TCI state) is configured, the DL RX spatial filter for a set of dedicated PDCCH (Physical Downlink Control Channel) receptions (a dedicated PDCCH reception is the PDCCH reception in RRC-connected mode) and all PDSCH (Physical Downlink Shared Channel) receptions and the UL TX spatial filter for a set of dedicated PUCCH transmissions (a dedicated PUCCH (Physical Uplink Control Channel) transmission is the PUCCH transmission in RRC-connected mode) and all PUSCH (Physical Uplink Shared Channel) transmissions are both determined by the QCL-TypeD RS contained in the joint DL/UL TCI state (referred to as joint TCI state hereinafter) indicated by a TCI field contained in a DCI or in a MAC CE (the MAC CE only activates one TCI state configured by RRC signaling). When separate DL/UL TCI (which means DL TCI state and UL TCI state are updated or activated separately) is configured, the DL RX spatial filter for a set of dedicated PDCCH receptions and all PDSCH receptions is determined by the QCL-TypeD RS contained in the DL TCI state indicated by a TCI field in a DCI or a MAC CE, while the UL TX spatial filter for a set of dedicated PUCCH transmissions and all PUSCH transmissions is directly indicated by the UL TCI state (i.e. the spatialRelationInfo RS contained in the UL TX state) indicated by the TCI field in a DCI or a MAC CE.

The joint TCI state or the DL TCI state can be configured by the following RRC signaling
TCI state

The IE TCI state associates one or two DL reference signals with a corresponding quasi-colocation (QCL) type.

TCI state information element

```
TCI state ::= SEQUENCE {
  TCI stateId TCI stateId,
  qc1-Type1 QCL-Info,
  qc1-Type2 QCL-Info
  ...
}
QCL-Info ::= SEQUENCE {
  cell ServCellIndex
  bwp-Id BWP-Id
  referenceSignal CHOICE {
    csi-rs NZP-CSI-RS-ResourceId,
    ssb SSB-Index
  },
  qc1-Type ENUMERATED {typeA, typeB,
  typeC, typeD},
  ...
}
```

Each TCI state contains parameters for configuring a quasi co-location (QCL) relationship between one or two downlink reference signals and the DM-RS (Demodulation reference signal) ports of the PDSCH, the DM-RS port of PDCCH or the CSI-RS port(s) of a CSI-RS (Channel State Information reference signal) resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values:

‘QCL-TypeA’: {Doppler shift, Doppler spread,
average delay, delay spread}
‘QCL-TypeB’: {Doppler shift, Doppler spread}
‘QCL-TypeC’: {Doppler shift, average delay}
‘QCL-TypeD’: {Spatial Rx parameter}

If a DL RS is configured in a TCI state with QCL-TypeD, this DL RS is called as the QCL-TypeD RS. If a TCI state is configured for a DL signal or a DL channel, it means that the DL signal or the DL channel is QCLed with the RS(s) contained in the TCI state with a QCL type as indicated in the TCI state. The UE shall determine the DL RX spatial filter and the UL TX spatial filter according to the QCL-TypeD RS in the joint TCI state.

For the case that the UE determine the UL TX spatial filter for a UL signal according to a DL RS, it means that the UE shall transmit the UL signal with the same spatial domain transmission filter used for the reception of the DL RS. The UL TCI state for separate DL/UL TCI indication contains at least a RS as the spatialRelationInfo by the following RRC signaling:

TCI state information element

```
UL TCI state ::= SEQUENCE {
  UL TCI stateId UL-TCI stateId,
  spatialRelationInfo CHOICE {
    csi-rs NZP-CSI-RS-ResourceId,
    ssb SSB-Index
    srs srs-ResourceId
  },
  ...
}
```

The RS configured as the spatialRelationInfo is called spatialRelationInfo RS, which is used to determine the UL TX spatial filter for the transmission of a UL signal. When a DL RS, e.g., CSI-RS or a SSB (Synchronization Signal/PBCH (Physical Broadcast channel)), is configured as the spatialRelationInfo RS, the UE shall transmit the UL signal with the same spatial domain transmission filter used for the reception of the DL RS. When a SRS resource is configured as the spatialRelationInfo RS, the UE shall transmit the UL signal with the same spatial domain transmission filter used for the transmission of the SRS resource.

A first embodiment relates to TCI states preparation and configuration for LTM.

The TCI states configuration including multiple TCI states of each candidate cell is provided by serving cell to the UE before sending a cell switch command (CSC) (e.g., carried by a LTM MAC CE), that is used to inform the UE to switch from the serving cell to a target cell (i.e., one of the candidate cells). The target cell is the candidate cell indicated in the LTM MAC CE. The source cell is the current serving cell before the UE switches to the target cell. A candidate cell TCI state activation command (e.g., a MAC CE) activates some TCI states from the multiple TCI states of the candidate cell(s). The cell switch command indicates one (e.g., joint) TCI state or a pair of (e.g., UL and DL) TCI states from the multiple TCI states of the target cell. The indicated one joint TCI state or the indicated pair of the UL and DL TCI states are used for data transmission and reception in the target cell.

It was agreed that each TCI state in the TCI states configuration should provide two different QCL types (e.g., QCL-Type A or QCL-Type C and QCL-Type D).

The first embodiment proposes that each joint TCI state or UL TCI state configured for each candidate cell should be associated with a PL-RS and/or a set of power control parameters for each UL channel or signal for UL transmission in the target cell (e.g., one of the candidate cells). The PL-RS is a DL RS, i.e., a CSI-RS or a SSB, for the UE to estimate the DL channel pathloss. The power control parameters set at least includes P0 (which configures the target receive power), alpha (which is the partial compensation factor) and closed loop index to indicate the closed loop for closed loop power control, for the UE to calculate the transmit power for each UL transmission.

The PL-RS is used for the UE to estimate the DL channel pathloss. The PL-RS should be QCLed with the QCL-TypeD RS configured in the TCI state for joint TCI state, and the PL-RS and the QCL-TypeD RS in the joint TCI state are associated with a same candidate cell or a same PCI (Physical Cell ID). The configured PL-RS should be one of the SSBs that are configured for L1 measurement for candidate cells. When the PL-RS is not configured for (i.e., associated with) the joint TCI state, the QCL-TypeD RS configured in the TCI state is used for the DL channel pathloss estimation. When the PL-RS is not configured for the UL TCI state, the spatialRelationInfo RS is used for the DL channel pathloss estimation.

Alternatively to associating a set of power control parameters with each joint TCI state or UL TCI state for a candidate cell, a dedicated power control parameter set at least including P0, alpha and closed loop index, which are used for the UE to calculate the transmit power for UL transmission, can be configured for the candidate cell. That is, if a set of power control parameters is not associated with each of the joint TCI state or UL TCI state of the candidate cell, the dedicated power control parameter set is assumed to be associated with the joint or UL TCI state of the candidate cell.

The indicated joint TCI state or pair of UL and DL TCI states for each candidate cell are used for UL (e.g., PUSCH and PUCCH) transmission as well as DL (e.g., PDSCH and PDCCH) reception. Take DL as an example, each joint TCI state or DL TCI state contains two different QCL types with a same or two different RSs. In NR Release 17, a TRS with QCL-Type A should be indicated for DL (PDSCH or PDCCH) DMRS (demodulation reference signal) demodulation. However, before switching to the target cell, the UE does not receive any TRS from candidate cell and cannot obtain the needed QCL parameters, e.g., Doppler shift, Doppler spread, average delay, and delay spread for DMRS demodulation. TRS is a CSI-RS with single port and is configured with a RRC parameter trs-info to identify the CSI-RS is a TRS.

In NR Release 18 LTM, only SSB based L1 measurement is supported. It means that only SSB from a candidate cell can be configured as an RS in the TCI state. However, only Doppler shift, average delay and spatial Rx filter can be obtained by SSB. It means that it's hard to obtain accurate Doppler spread and delay spread based on SSB with limited bandwidth.

In other words, full QCL-TypeA parameters (i.e., Doppler shift, Doppler spread, average delay and delay spread) for PDSCH or PDCCH reception may not be obtained from a SSB configured in a TCI state.

In view of the above, the first embodiment proposes two options:

### Option 1-1:

The indicated TCI state includes 2 qcl-types (qcl-Type1 and qcl-Type2), where qcl-Type1 indicates an SSB with QCL-TypeA (Doppler shift, Doppler spread, average delay, and delay spread) and qcl-Type2 indicates the same SSB with QCL-TypeD. It means that SSB can be used for DL (e.g., CSI-RS, PDSCH, PDCCH) reception with both QCL-TypeA and QCL-TypeD. Option 1 is different from the QCL principle in NR Release 17. In Option 1-1, only SSB used for L1 measurement can be associated with the indicated TCI state as the PL-RS.

As described above, it's hard for the UE to obtain accurate doppler spread and delay spread cannot be obtained by SSB. So, according to Option 1-1, it is up to UE implementation to assume default values of the doppler spread and the delay spread if an SSB with QCL-TypeA is indicated in the indicated TCI state.

### a Variety of Option 1-1:

The indicated TCI state includes 2 qcl-types (qcl-Type1 and qcl-Type2), where qcl-Type1 indicates an SSB with QCL-TypeC (Doppler shift, and average delay) and qcl-Type2 indicates the same SSB with QCL-TypeD.

### Option 1-2:

The QCL principle in NR Release 17 is used. That is, the indicated TCI state includes 2 qcl-types (qcl-Type1 and qcl-Type2), where qcl-Type1 indicates a TRS with QCL-TypeA (Doppler shift, Doppler spread, average delay, and delay spread) and qcl-Type2 indicates the same TRS with QCL-TypeD. In addition, the indicated TRS is QCLed with a SSB configured for L1 measurement with respect to QCL-TypeC and QCL-TypeD for the same candidate cell. Since the UE does not receive the TRS from a target cell (e.g., one of candidate cells) before switching to the target cell, the UE may assume the TRS in the indicated TCI state is transmitted in the first K (where K is an integer and K>=1) slots after the UE switch to the target cell. The resource and qcl-info configuration for the TRS which are configured for any one of the TCI state of a candidate cell are provided along with the TCI states configuration for each candidate cell. In particular, if any TCI state of a candidate cell includes a TRS, the resource and qcl-info configuration for the TRS are provided along with the TCI states configuration for the candidate cell.

A second embodiment relates to TCI state mapping in target cell with early TCI activation.

The TCI states configuration including multiple TCI states of each candidate cell is provided by serving cell to the UE. Early TCI activation means that some TCI states from the multiple TCI states of the candidate cell(s) are activated, e.g., by a candidate cell TCI state activation command, before the UE receives a cell switch command (CSC). After the UE switches to the target cell (e.g., one of the candidate cells), if no new activation of the TCI states for the target cell is performed, the activated TCI states for the target cell can be indicated by a DCI format 1_1 or 1_2 for unified TCI state(s) indication.

The activation of TCI states for multiple candidate cells can be made in two options:

### Option 2-1:

A single (i.e., one) MAC CE activates TCI states for one candidate cell. So, multiple (e.g., N, which is a positive integer) MAC CEs are necessary for activating TCI states of the same number of (e.g., N) candidate cells. Option 2-1 applies to the situation in which a separate TCI state pool is configured for each candidate cell. Incidentally, for separate TCI mode, the TCI states should be activated per TCI state pair including a UL TCI state and a DL TCI state.

### Option 2-2:

A single (i.e., one) MAC CE activates TCI states for multiple (e.g., all) candidate cells. Option 2-2 applies to the situation in which a single TCI state pool that contains TCI states for all (e.g., the multiple) candidate cells is configured, and each TCI state is associated with a candidate cell index or a PCI (physical cell index). Similar to Option 2-1, for separate TCI mode in Option 2-2, the TCI states should be activated per TCI state pair including a UL TCI state and a DL TCI state.

After the TCI state(s) of a candidate cell are activated, the activated TCI state(s) shall be mapped to each of the TCI codepoints indicated by DCI format 1_1 or 1_2 in the target cell after the UE switches to a target cell that is the candidate cell.

The second embodiment proposes the following mapping scheme when two or more TCI states (or two or more pairs of TCI states) of a candidate cell are activated before LTM and the candidate cell is the target cell indicated by the LTM MAC CE carrying the CSC.

For joint TCI mode, the first activated TCI state for the target cell is mapped to the first TCI codepoint, i.e., TCI codepoint value 000, of DCI format 1_1 or 1_2 of the target cell; the second activated TCI state for the target cell is mapped to the second TCI codepoint, i.e., TCI codepoint value 001, of DCI format 1_1 or 1_2 of the target cell, and so on. That is, the N^{th} activated TCI state for the target cell is mapped to the N^{th} TCI codepoint of DCI format 1_1 or 1_2 of the target cell.

For separate TCI mode, the first pair of activated TCI states (i.e., the first pair of activated UL and DL TCI states) is mapped to the first TCI codepoint, i.e., TCI codepoint value 000, of DCI format 1_1 or 1_2 of the target cell, the second pair of activated TCI states (i.e., the second pair of activated UL and DL TCI states) is mapped to the second TCI codepoint, i.e., TCI codepoint value 001, of DCI format 1_1 or 1_2 of the target cell, and so on. That is, the N^{th} pair of activated TCI states for the target cell is mapped to the N^{th} TCI codepoint of DCI format 1_1 or 1_2 of the target cell.

Considering that the candidate cells for the target cell may be changed and different from those for the source serving cell, the UE may assume that the activated TCI states for all other candidate cells each of which is not the target cell indicated by the LTM MAC CE and the activated TCI states for the source serving cell are deactivated in the target cell.

A third embodiment relates to enhanced beam report.

RAN4 introduced an optional UE feature to report L3 measurement results in L1 beam report without expected RAN1 impact.

From network perspective, an L3 measurement result, which corresponds to filtered RSRP (Reference Signal Receiving Power), and an L1 measurement result, which corresponds to L1-RSRP, are different. For example, L3 measurement result is a more stable result for the network to make LTM decision, while L1 measurement result is more useful for beam activation and indication for candidate cells.

In view of the above, it is better to let the network (e.g., gNB) know the reported measurement result is a L1 measurement result or a L3 measurement result.

The third embodiment proposed two options.

Option 3-1: If a UE reports a capability to report L3 measurement results in L1 beam report, gNB can configure a beam report for the UE and indicate the UE to report L1 measurement result (e.g., L1 RSRP) or L3 measurement result (e.g., L3 filtered RSRP). For example, the gNB can configure a CSI-ReportConfig with the parameter reportQuality set to SSBRI-FilteredRSRP, so as to indicate the UE to report L3 filtered RSRP. The gNB can configure a CSI-ReportConfig with the parameter reportQuality set to SSBRI-RSRP, so as to indicate the UE to report L1 RSRP.

Option 3-2: It is up to UE to determine to report L1 measurement result (e.g., L1 RSRP) or L3 measurement result (e.g., L3 filtered RSRP) in each beam report. The UE needs to indicate the reported RSRP is a L1 RSRP or a L3 filtered RSRP. For example, a one-bit indication can be included in each beam report. If the UE indicates the reported RSRPs are L1 measurement result, all the reported RSRPs correspond to L1-RSRP. If the UE indicates the reported RSRPs are L3 measurement result, all the reported RSRPs correspond to L3 filtered RSRP.

When the reported RSRPs correspond to L3 filtered RSRP, the gNB shall assume that the reported RSRPs are obtained in the latest available measurement gap, and that the determined measurement gap should ensure the UE to be able to obtain the required results for reporting.

A fourth embodiment relates to application time of the LTM MAC CE.

The CSC is carried by a MAC CE (e.g., LTM MAC CE). A new joint TCI state or a new pair of UL TCI state and DL TCI state for the target cell different from that or those for the source cell are indicated in the LTM MAC CE. It is necessary to determine when the CSC is applied. An example of the LTM timing is illustrates in FIG. 5.

After the UE acknowledges the receipt of the PDSCH carrying the LTM MAC CE, a time period, i.e., application time of the CSC of LTM, is necessary before the first slot of the target cell (i.e., new serving cell).

During the application time period, the following operations are necessary to complete:

Necessary RRC updating. For example, the decoding of candidate cell configuration corresponding to the target cell shall be completed, and the LTM complete message shall be prepared. The required time for necessary RRC updating is denoted as T_{RRC}.

Switching to the new Tx and Rx beam(s) corresponding to the indicated TCI state(s) for the target cell. The required time for the switching is denoted as T_{BAT} which is equal to beam application time for unified beam update, i.e., BeamAppTime-r17.

RF retuning at least for inter-frequency handover. For inter-frequency handover, the RF retuning from the frequency of the source cell to the frequency of the target cell shall be completed. The required time for RF retuning is de denoted as T_{RF}. T_{RF} may be equal to 0 for intra-frequency handover, in which RF retuning may be unnecessary.

In addition to T_{RRC}, T_{BAT}, and T_{RF}, the regular MAC CE application time for a MAC CE (e.g., the LTM MAC CE carrying the CSC), i.e.,

$$3 {N}_{slot}^{subframe , μ} ,$$

shall be considered as well.

The fourth embodiment proposes three options to determine the application time (denoted as T_{LTM}) of the LTM MAC CE if the target cell is not one of the current serving cells.

Option 4-1: The application time is defined by

$${T}_{LTM} = max \{ 3 {N}_{slot}^{subframe , μ} ,$$

T_{BAT}, T_{RRC}, T_{RF}}, where max {A, B, C . . . } means the maximum value of A, B, C, . . .

Option 4-2: The application time is defined by

$${T}_{LTM} = 3 {N}_{slot}^{subframe , μ} + max \{ {T}_{B A T} , {T}_{R R C} , {T}_{R F} \} .$$

Option 4-3: The application time is defined by

$${T}_{LTM} = 3 {N}_{slot}^{subframe , μ} + k ,$$

where the value of k can be a specific or predetermined value, e.g., configured by RRC or reported by UE capability.

Incidentally, if the target cell is one of the current serving cells, the application time is defined by

$${T}_{LTM} = 3 {N}_{slot}^{subframe , μ} .$$

The application time T_{LTM} may be in unit of symbols.

In addition, the application time T_{LTM} may be determined (e.g., calculated) based on the SCS of serving cell, e.g., the UL SCS of the serving cell (i.e., source cell), or the smallest value of the SCS of the serving cell and the SCS of the target cell.

A fifth embodiment relates to some UE behavior after switching to the target cell.

After the UE switches to the target cell, the RS corresponding to the QCL-TypeD RS configured in the indicated joint or DL TCI state in the CSC MAC CE is updated as the beam failure detection (RFD) RS in the target cell. In addition, the corresponding beam failure indication counter of the BFD RS set is set to zero.

A power headroom report is triggered in the first slot applying the LTM MAC CE, at least for the situation that the target cell is not one of the current serving cells. If there is no actual PUSCH transmission, the power headroom is calculated based on a reference PUSCH transmission using the power control parameters associated with the indicated joint or UL TCI state.

In some aspects, items as examples of the disclosure concerning UE or base station may be summarized as follows:

1. A user equipment (UE) for wireless communication, comprising:
at least one memory; and
at least one processor coupled with the at least one memory and configured to cause the UE to:
receive a TCI states configuration of each of one or multiple candidate cells, wherein, the TCI states configuration includes multiple TCI states, and each TCI state provides two different QCL types.

2. The UE of item 1, wherein, each TCI state includes a QCL-type A SSB and the same SSB with QCL-type D.

3. The UE of item 1, wherein, each TCI state includes a QCL-type C SSB and the same SSB with QCL-type D.

4. The UE of item 1, wherein, each TCI state includes a QCL-type A TRS and the same TRS with QCL-type D and the TRS is further QCLed with a SSB from the same candidate cell.

5. The UE of item 4, wherein, the at least one processor is further configured to cause the UE to: receive the TRS in the first K slots after switching to a target cell that is the candidate cell, where K>=1.

6. The UE of item 1, wherein, each TCI state is associated with a PL-RS and/or a set of power control parameters.

7. The UE of item 1, wherein, a dedicated power control parameter set is configured for a candidate cell.

8. The UE of item 1, wherein, QCL-TypeD RS in joint TCI state is assumed as the default PL-RS for the joint TCI state, and DL RS for UL spatial Tx filter determination in UL TCI state is assumed as the default PL-RS for the UL TCI state.

9. The UE of item 1, wherein, after switching to a target cell, for joint TCI mode, the N^{th} activated TCI state for the target cell is mapped to the N^{th} TCI codepoint of DCI format 1_1 or 1_2 of the target cell, where N is a positive integer.

10. The UE of item 1, wherein, after switching to a target cell, for separate TCI mode, the N^{th} activated pair of TCI states for the target cell is mapped to the N^{th} TCI codepoint of DCI format 1_1 or 1_2 of the target cell, where N is a positive integer.

11. The UE of item 1, wherein, the at least one processor is further configured to cause the UE to: transmit a beam report including a L1 measurement result or a L3 measurement result, wherein, the beam report further includes an indication to indicate whether the L1 measurement result or the L3 measurement result is included in the beam report.

12. The UE of item 1, wherein, the at least one processor is further configured to cause the UE to: receive a MAC CE carrying a cell switch command, wherein an application time of the cell switching command is determined by one of a), b) and c) if the target cell indicated in the cell switch command is not one of the current serving cells, and is determined by d) if the target cell is one of the current serving cells: a) max

$$\{ 3 {N}_{slot}^{subframe , μ} , {T}_{B A T} , {T}_{R R C} , {T}_{R F} \} ;$$

$$b ) 3 {N}_{slot}^{subframe , μ} + max \{ {T}_{BAT} , {T}_{R R C} , {T}_{R F} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

13. The UE of item 12, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

14. A processor in a UE for wireless communication, comprising:
at least one controller coupled with at least one memory and configured to cause the processor to: receive a TCI states configuration of each of one or multiple candidate cells, wherein, the TCI states configuration includes multiple TCI states, and each TCI state provides two different QCL types.

15. The processor of item 14, wherein, each TCI state includes a QCL-type A SSB and the same SSB with QCL-type D.

16. The processor of item 14, wherein, each TCI state includes a QCL-type C SSB and the same SSB with QCL-type D.

17. The processor of item 14, wherein, each TCI state includes a QCL-type A TRS and the same TRS with QCL-type D and the TRS is further QCLed with a SSB from the same candidate cell.

18. The processor of item 17, wherein, the at least one controller is further configured to cause the processor to: receive the TRS in the first K slots after switching to a target cell that is the candidate cell, where K>=1.

19. The processor of item 14, wherein, each TCI state is associated with a PL-RS and/or a set of power control parameters.

20. The processor of item 14, wherein, a dedicated power control parameter set is configured for a candidate cell.

21. The processor of item 14, wherein, QCL-TypeD RS in joint TCI state is assumed as the default PL-RS for the joint TCI state, and DL RS for UL spatial Tx filter determination in UL TCI state is assumed as the default PL-RS for the UL TCI state.

22. The processor of item 14, wherein, after the UE switching to a target cell, for joint TCI mode, the N^{th} activated TCI state for the target cell is mapped to the N^{th} TCI codepoint of DCI format 1_1 or 1_2 of the target cell, where N is a positive integer.

23. The processor of item 14, wherein, after the UE switching to a target cell, for separate TCI mode, the N^{th} activated pair of TCI states for the target cell is mapped to the N^{th} TCI codepoint of DCI format 1_1 or 1_2 of the target cell, where N is a positive integer.

24. The processor of item 14, wherein, the at least one controller is further configured to cause the processor to: transmit a beam report including a L1 measurement result or a L3 measurement result, wherein, the beam report further includes an indication to indicate whether the L1 measurement result or the L3 measurement result is included in the beam report.

25. The processor of item 14, wherein, the at least one controller is further configured to cause the processor to: receive a MAC CE carrying a cell switch command, wherein an application time of the cell switching command is determined by one of a), b) and c) if the target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

26. The processor of item 25, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

27. A method performed by a user equipment (UE), the method comprising:
receiving a TCI states configuration of each of one or multiple candidate cells, wherein, the TCI states configuration includes multiple TCI states, and each TCI state provides two different QCL types.

28. The method of item 27, wherein, each TCI state includes a QCL-type A SSB and the same SSB with QCL-type D.

29. The method of item 27, wherein, each TCI state includes a QCL-type C SSB and the same SSB with QCL-type D.

30. The method of item 27, wherein, each TCI state includes a QCL-type A TRS and the same TRS with QCL-type D and the TRS is further QCLed with a SSB from the same candidate cell.

31. The method of item 30, further comprising: receiving the TRS in the first K slots after switching to a target cell that is the candidate cell, where K>=1.

32. The method of item 27, wherein, each TCI state is associated with a PL-RS and/or a set of power control parameters.

33. The method of item 27, wherein, a dedicated power control parameter set is configured for a candidate cell.

34. The method of item 27, wherein, QCL-TypeD RS in joint TCI state is assumed as the default PL-RS for the joint TCI state, and DL RS for UL spatial Tx filter determination in UL TCI state is assumed as the default PL-RS for the UL TCI state.

35. The method of item 27, wherein, after the UE switching to a target cell, for joint TCI mode, the N^{th} activated TCI state for the target cell is mapped to the N^{th} TCI codepoint of DCI format 1_1 or 1_2 of the target cell, where N is a positive integer.

36. The method of item 27, wherein, after the UE switching to a target cell, for separate TCI mode, the N′ activated pair of TCI states for the target cell is mapped to the N^{th} TCI codepoint of DCI format 1_1 or 1_2 of the target cell, where N is a positive integer.

37. The method of item 27, further comprising: transmitting a beam report including a L1 measurement result or a L3 measurement result, wherein, the beam report further includes an indication to indicate whether the L1 measurement result or the L3 measurement result is included in the beam report.

38. The method of item 27, further comprising: receiving a MAC CE carrying a cell switch command, wherein an application time of the cell switching command is determined by one of a), b) and c) if the target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

39. The method of item 38, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

40. A base station for wireless communication, comprising:
at least one memory; and
at least one processor coupled with the at least one memory and configured to cause the base station to:
transmit a TCI states configuration of each of one or multiple candidate cells, wherein, the TCI states configuration includes multiple TCI states, and each TCI state provides two different QCL types.

41. The base station of item 40, wherein, each TCI state includes a QCL-type A SSB and the same SSB with QCL-type D.

42. The base station of item 40, wherein, each TCI state includes a QCL-type C SSB and the same SSB with QCL-type D.

43. The base station of item 40, wherein, each TCI state includes a QCL-type A TRS and the same TRS with QCL-type D and the TRS is further QCLed with a SSB from the same candidate cell.

44. The base station of item 43, wherein, the at least one processor is further configured to cause the base station to: transmit the TRS in the first K slots after a UE switching to a target cell that is the candidate cell, where K>=1.

45. The base station of item 40, wherein, each TCI state is associated with a PL-RS and/or a set of power control parameters.

46. The base station of item 40, wherein, a dedicated power control parameter set is configured for a candidate cell.

47. The base station of item 40, wherein, QCL-TypeD RS in joint TCI state is assumed as the default PL-RS for the joint TCI state, and DL RS for UL spatial Tx filter determination in UL TCI state is assumed as the default PL-RS for the UL TCI state.

48. The base station of item 40, wherein, after a UE switching to a target cell, for joint TCI mode, the N^{th} activated TCI state for the target cell is mapped to the N^{th} TCI codepoint of DCI format 1_1 or 1_2 of the target cell, where N is a positive integer.

49. The base station of item 40, wherein, after a UE switching to a target cell, for separate TCI mode, the N′ activated pair of TCI states for the target cell is mapped to the N^{th} TCI codepoint of DCI format 1_1 or 1_2 of the target cell, where N is a positive integer.

50. The base station of item 40, wherein, the at least one processor is further configured to cause the base station to: receive a beam report including a L1 measurement result or a L3 measurement result, wherein, the beam report further includes an indication to indicate whether the L1 measurement result or the L3 measurement result is included in the beam report.

51. The base station of item 40, wherein, the at least one processor is further configured to cause the base station to: transmit a MAC CE carrying a cell switch command, wherein an application time of the cell switching command is determined by one of a), b) and c) if the target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

52. The UE of item 51, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

53. A processor in a base station for wireless communication, comprising:
at least one controller coupled with at least one memory and configured to cause the processor to: transmit a TCI states configuration of each of one or multiple candidate cells, wherein, the TCI states configuration includes multiple TCI states, and each TCI state provides two different QCL types.

54. The processor of item 53, wherein, each TCI state includes a QCL-type A SSB and the same SSB with QCL-type D.

55. The processor of item 53, wherein, each TCI state includes a QCL-type C SSB and the same SSB with QCL-type D.

56. The processor of item 53, wherein, each TCI state includes a QCL-type A TRS and the same TRS with QCL-type D and the TRS is further QCLed with a SSB from the same candidate cell.

57. The processor of item 56, wherein, the at least one controller is further configured to cause the processor to: transmit the TRS in the first K slots after a UE switching to a target cell that is the candidate cell, where K>=1.

58. The processor of item 53, wherein, each TCI state is associated with a PL-RS and/or a set of power control parameters.

59. The processor of item 53, wherein, a dedicated power control parameter set is configured for a candidate cell.

60. The processor of item 53, wherein, QCL-TypeD RS in joint TCI state is assumed as the default PL-RS for the joint TCI state, and DL RS for UL spatial Tx filter determination in UL TCI state is assumed as the default PL-RS for the UL TCI state.

61. The processor of item 53, wherein, after a UE switching to a target cell, for joint TCI mode, the N^{th} activated TCI state for the target cell is mapped to the N^{th} TCI codepoint of DCI format 1_1 or 1_2 of the target cell, where N is a positive integer.

62. The processor of item 53, wherein, after a UE switching to a target cell, for separate TCI mode, the N^{th} activated pair of TCI states for the target cell is mapped to the N^{th} TCI codepoint of DCI format 1_1 or 1_2 of the target cell, where N is a positive integer.

63. The processor of item 53, wherein, the at least one controller is further configured to cause the processor to: receive a beam report including a L1 measurement result or a L3 measurement result, wherein, the beam report further includes an indication to indicate whether the L1 measurement result or the L3 measurement result is included in the beam report.

64. The processor of item 53, wherein, the at least one controller is further configured to cause the processor to: transmit a MAC CE carrying a cell switch command, wherein an application time of the cell switching command is determined by one of a), b) and c) if the target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

65. The processor of item 64, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

66. A method performed by a base station, the method comprising:
transmitting a TCI states configuration of each of one or multiple candidate cells, wherein, the TCI states configuration includes multiple TCI states, and each TCI state provides two different QCL types.

67. The method of item 66, wherein, each TCI state includes a QCL-type A SSB and the same SSB with QCL-type D.

68. The method of item 66, wherein, each TCI state includes a QCL-type C SSB and the same SSB with QCL-type D.

69. The method of item 66, wherein, each TCI state includes a QCL-type A TRS and the same TRS with QCL-type D and the TRS is further QCLed with a SSB from the same candidate cell.

70. The method of item 69, further comprising: transmitting the TRS in the first K slots after a UE switching to a target cell that is the candidate cell, where K>=1.

71. The method of item 66, wherein, each TCI state is associated with a PL-RS and/or a set of power control parameters.

72. The method of item 66, wherein, a dedicated power control parameter set is configured for a candidate cell.

73. The method of item 66, wherein, QCL-TypeD RS in joint TCI state is assumed as the default PL-RS for the joint TCI state, and DL RS for UL spatial Tx filter determination in UL TCI state is assumed as the default PL-RS for the UL TCI state.

74. The method of item 66, wherein, after a UE switching to a target cell, for joint TCI mode, the N^{th} activated TCI state for the target cell is mapped to the N^{th} TCI codepoint of DCI format 1_1 or 1_2 of the target cell, where N is a positive integer.

75. The method of item 66, wherein, after a UE switching to a target cell, for separate TCI mode, the N′ activated pair of TCI states for the target cell is mapped to the N^{th} TCI codepoint of DCI format 1_1 or 1_2 of the target cell, where N is a positive integer.

76. The method of item 66, further comprising: receiving a beam report including a L1 measurement result or a L3 measurement result, wherein, the beam report further includes an indication to indicate whether the L1 measurement result or the L3 measurement result is included in the beam report.

77. The method of item 66, further comprising: transmitting a MAC CE carrying a cell switch command, wherein an application time of the cell switching command is determined by one of a), b) and c) if the target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

78. The method of item 77, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

In some aspects, second items as examples of the disclosure concerning UE or base station may be summarized as follows:

Second item 1. A user equipment (UE) for wireless communication, comprising:
at least one memory; and
at least one processor coupled with the at least one memory and configured to cause the UE to:
receive a TCI states configuration of each of one or multiple candidate cells, and
receive one or more MAC CEs to activate one or more TCI states for the one or multiple candidate cells.

2. The UE of second item 1, wherein, after switching to a target cell, for joint TCI mode, the N^{th} activated TCI state for the target cell is mapped to the N^{th} TCI codepoint of DCI format 1_1 or 1_2 of the target cell, where N is a positive integer.

3. The UE of second item 1, wherein, after switching to a target cell, for separate TCI mode, the N^{th} activated pair of TCI states for the target cell is mapped to the N^{th} TCI codepoint of DCI format 1_1 or 1_2 of the target cell, where N is a positive integer.

4. A processor in a UE for wireless communication, comprising:
at least one controller coupled with at least one memory and configured to cause the processor to:
receive a TCI states configuration of each of one or multiple candidate cells, and
receive one or more MAC CEs to activate one or more TCI states for the one or multiple candidate cells.

5. The processor of second item 4, wherein, after switching to a target cell, for joint TCI mode, the N^{th} activated TCI state for the target cell is mapped to the N^{th} TCI codepoint of DCI format 1_1 or 1_2 of the target cell, where N is a positive integer.

6. The processor of second item 4, wherein, after switching to a target cell, for separate TCI mode, the N^{th} activated pair of TCI states for the target cell is mapped to the N^{th} TCI codepoint of DCI format 1_1 or 1_2 of the target cell, where N is a positive integer.

7. A method performed by a user equipment (UE), the method comprising:
receiving a TCI states configuration of each of one or multiple candidate cells, and
receiving one or more MAC CEs to activate one or more TCI states for the one or multiple candidate cells.

8. The method of second item 7, wherein, after switching to a target cell, for joint TCI mode, the N^{th} activated TCI state for the target cell is mapped to the N^{th} TCI codepoint of DCI format 1_1 or 1_2 of the target cell, where N is a positive integer.

9. The method of second item 7, wherein, after switching to a target cell, for separate TCI mode, the N^{th} activated pair of TCI states for the target cell is mapped to the N^{th} TCI codepoint of DCI format 1_1 or 1_2 of the target cell, where N is a positive integer.

10. A base station for wireless communication, comprising:
at least one memory; and
at least one processor coupled with the at least one memory and configured to cause the base station to:
transmit a TCI states configuration of each of one or multiple candidate cells, and
transmit one or more MAC CEs to activate one or more TCI states for the one or multiple candidate cells.

11. The base station of second item 10, wherein, after switching to a target cell, for joint TCI mode, the N^{th} activated TCI state for the target cell is mapped to the N^{th} TCI codepoint of DCI format 1_1 or 1_2 of the target cell, where N is a positive integer.

12. The base station of second item 10, wherein, after switching to a target cell, for separate TCI mode, the N^{th} activated pair of TCI states for the target cell is mapped to the N^{th} TCI codepoint of DCI format 1_1 or 1_2 of the target cell, where N is a positive integer.

13. A processor in a base station for wireless communication, comprising:
at least one controller coupled with at least one memory and configured to cause the processor to:
transmit a TCI states configuration of each of one or multiple candidate cells, and
transmit one or more MAC CEs to activate one or more TCI states for the one or multiple candidate cells.

14. The processor of second item 13, wherein, after switching to a target cell, for joint TCI mode, the N^{th} activated TCI state for the target cell is mapped to the N^{th} TCI codepoint of DCI format 1_1 or 1_2 of the target cell, where N is a positive integer.

15. The processor of second item 13, wherein, after switching to a target cell, for separate TCI mode, the N′ activated pair of TCI states for the target cell is mapped to the N^{th} TCI codepoint of DCI format 1_1 or 1_2 of the target cell, where N is a positive integer.

16. A method performed by a base station, the method comprising:
transmitting a TCI states configuration of each of one or multiple candidate cells, and
transmitting one or more MAC CEs to activate one or more TCI states for the one or multiple candidate cells.

17. The method of second item 16, wherein, after switching to a target cell, for joint TCI mode, the N^{th} activated TCI state for the target cell is mapped to the N^{th} TCI codepoint of DCI format 1_1 or 1_2 of the target cell, where N is a positive integer.

18. The method of second item 16, wherein, after switching to a target cell, for separate TCI mode, the N″ activated pair of TCI states for the target cell is mapped to the N^{th} TCI codepoint of DCI format 1_1 or 1_2 of the target cell, where N is a positive integer.

In some aspects, third items as examples of the disclosure concerning UE or base station may be summarized as follows:

Third item 1. A user equipment (UE) for wireless communication, comprising:
at least one memory; and
at least one processor coupled with the at least one memory and configured to cause the UE to:
transmit a beam report including a L1 measurement result or a L3 measurement result.

2. The UE of third item 1, wherein, the beam report further includes an indication to indicate whether the L1 measurement result or the L3 measurement result is included in the beam report.

3. The UE of third item 1, wherein, the at least one processor is further configured to cause the UE to:
transmit a capability to report L3 measurement result; and
receive a configuration of the beam report on whether the L1 measurement result or the L3 measurement result is included in the beam report.

4. A processor in a UE for wireless communication, comprising:
at least one controller coupled with at least one memory and configured to cause the processor to:
transmit a beam report including a L1 measurement result or a L3 measurement result.

5. The processor of third item 4, wherein, the beam report further includes an indication to indicate whether the L1 measurement result or the L3 measurement result is included in the beam report.

6. The processor of third item 4, wherein, the at least one controller is further configured to cause the processor to:
transmit a capability to report L3 measurement result; and
receive a configuration of the beam report on whether the L1 measurement result or the L3 measurement result is included in the beam report.

7. A method performed by a user equipment (UE), the method comprising:
transmitting a beam report including a L1 measurement result or a L3 measurement result.

8. The method of third item 7, wherein, the beam report further includes an indication to indicate whether the L1 measurement result or the L3 measurement result is included in the beam report.

9. The method of third item 7, further comprising:
transmitting a capability to report L3 measurement result; and
receiving a configuration of the beam report on whether the L1 measurement result or the L3 measurement result is included in the beam report.

10. A base station for wireless communication, comprising:
at least one memory; and
at least one processor coupled with the at least one memory and configured to cause the base station to:
receive a beam report including a L1 measurement result or a L3 measurement result.

11. The base station of third item 10, wherein, the beam report further includes an indication to indicate whether the L1 measurement result or the L3 measurement result is included in the beam report.

12. The base station of third item 10, the at least one processor is further configured to cause the base station to:
receive a capability to report L3 measurement result; and
transmit a configuration of the beam report on whether the L1 measurement result or the L3 measurement result is included in the beam report.

13. A processor in a base station for wireless communication, comprising:
at least one controller coupled with at least one memory and configured to cause the processor to:
receive a beam report including a L1 measurement result or a L3 measurement result.

14. The processor of third item 13, wherein, the beam report further includes an indication to indicate whether the L1 measurement result or the L3 measurement result is included in the beam report.

15. The processor of third item 13, wherein, the at least one controller is further configured to cause the processor to:
receive a capability to report L3 measurement result; and
transmit a configuration of the beam report on whether the L1 measurement result or the L3 measurement result is included in the beam report.

16. A method performed by a base station, the method comprising:
receiving a beam report including a L1 measurement result or a L3 measurement result.

17. The method of third item 16, wherein, the beam report further includes an indication to indicate whether the L1 measurement result or the L3 measurement result is included in the beam report.

18. The method of third item 16, further comprising:
receiving a capability to report L3 measurement result; and
transmitting a configuration of the beam report on whether the L1 measurement result or the L3 measurement result is included in the beam report.

In some aspects, fourth items as examples of the disclosure concerning UE or base station may be summarized as follows:

Fourth item 1. A user equipment (UE) for wireless communication, comprising:
at least one memory; and
at least one processor coupled with the at least one memory and configured to cause the UE to:
receive a MAC CE carrying a cell switch command, wherein an application time of the cell switching command is determined by one of a), b) and c) if a target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

2. The UE of fourth item 1, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

3. A processor in a UE for wireless communication, comprising:
at least one controller coupled with at least one memory and configured to cause the processor to:
receive a MAC CE carrying a cell switch command, wherein an application time of the cell switching command is determined by one of a), b) and c) if a target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

4. The processor of fourth item 3, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

5. A method performed by a user equipment (UE), the method comprising:
receiving a MAC CE carrying a cell switch command, wherein an application time of the cell switching command is determined by one of a), b) and c) if a target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

6. The method of fourth item 5, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

7. A base station for wireless communication, comprising:
at least one memory; and
at least one processor coupled with the at least one memory and configured to cause the base station to:
transmit a MAC CE carrying a cell switch command, wherein an application time of the cell switching command is determined by one of a), b) and c) if a target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

8. The base station of fourth item 7, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

9. A processor in a base station for wireless communication, comprising:
at least one controller coupled with at least one memory and configured to cause the processor to:
transmit a MAC CE carrying a cell switch command, wherein an application time of the cell switching command is determined by one of a), b) and c) if a target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

10. The processor of fourth item 9, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

11. A method performed by a base station, the method comprising:
transmitting a MAC CE carrying a cell switch command, wherein an application time of the cell switching command is determined by one of a), b) and c) if a target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

12. The method of fourth item 11, wherein, the MAC CE further indicates a joint TCI state or a pair of UL TCI state and DL TCI state, and the RS corresponding to the QCL-TypeD RS in the joint or DL TCI state is set as the beam failure detection RS after the application time of the cell switching command.

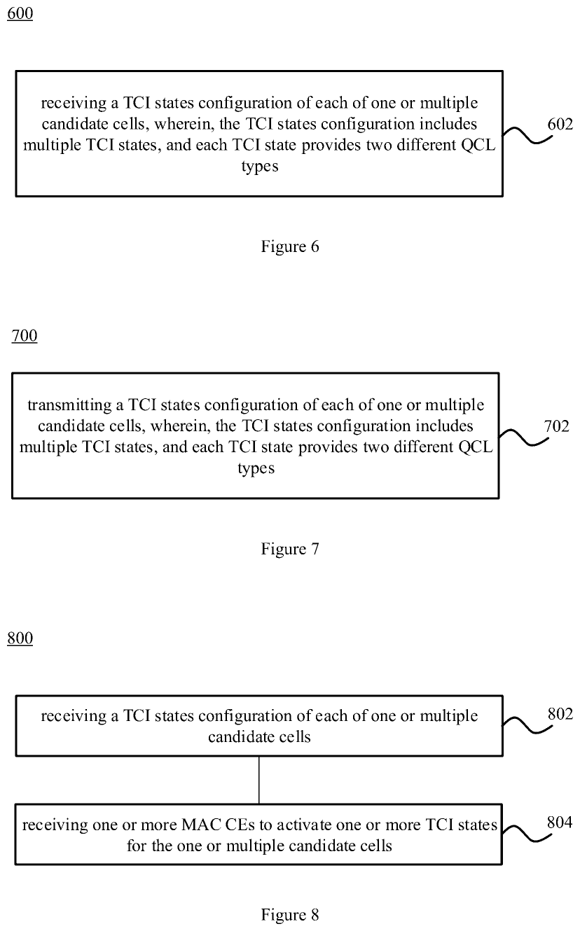

FIG. 6 illustrates a flowchart of a method 600 in accordance with aspects of the present disclosure. The operations of the method may be implemented by a UE as described herein. In some implementations, the UE may execute a set of instructions to control the function elements of the UE to perform the described functions.

At 602, receiving a TCI states configuration of each of one or multiple candidate cells, wherein, the TCI states configuration includes multiple TCI states, and each TCI state provides two different QCL types.

FIG. 7 illustrates a flowchart of a method 700 in accordance with aspects of the present disclosure. The operations of the method may be implemented by a NE as described herein. In some implementations, the NE may execute a set of instructions to control the function elements of the NE to perform the described functions.

At 702, transmitting a TCI states configuration of each of one or multiple candidate cells, wherein, the TCI states configuration includes multiple TCI states, and each TCI state provides two different QCL types.

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions.

At 802, receiving a TCI states configuration of each of one or multiple candidate cells.

At 804, receiving one or more MAC CEs to activate one or more TCI states for the one or multiple candidate cells.

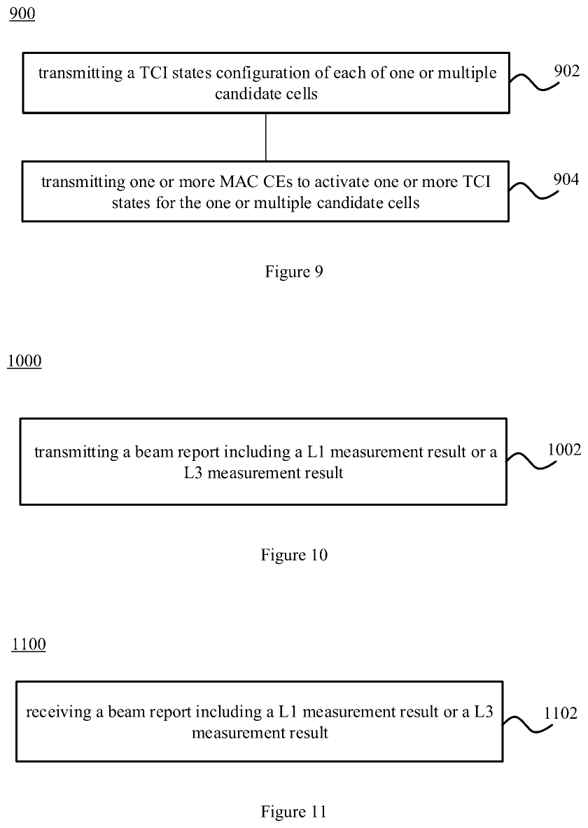

FIG. 9 illustrates a flowchart of a method 900 in accordance with aspects of the present disclosure. The operations of the method may be implemented by a NE as described herein. In some implementations, the NE may execute a set of instructions to control the function elements of the NE to perform the described functions.

At 902, transmitting a TCI states configuration of each of one or multiple candidate cells.

At 904, transmitting one or more MAC CEs to activate one or more TCI states for the one or multiple candidate cells.

FIG. 10 illustrates a flowchart of a method 1000 in accordance with aspects of the present disclosure. The operations of the method may be implemented by a UE as described herein. In some implementations, the UE may execute a set of instructions to control the function elements of the UE to perform the described functions.

At 1002, transmitting a beam report including a L1 measurement result or a L3 measurement result.

FIG. 11 illustrates a flowchart of a method 1100 in accordance with aspects of the present disclosure. The operations of the method may be implemented by a NE as described herein. In some implementations, the NE may execute a set of instructions to control the function elements of the NE to perform the described functions.

At 1102, receiving a beam report including a L1 measurement result or a L3 measurement result.

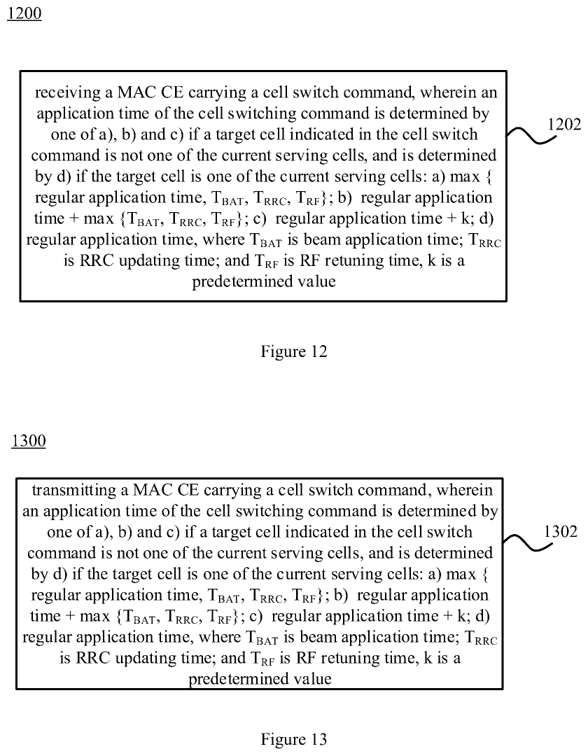

FIG. 12 illustrates a flowchart of a method 1200 in accordance with aspects of the present disclosure. The operations of the method may be implemented by a UE as described herein. In some implementations, the UE may execute a set of instructions to control the function elements of the UE to perform the described functions.

At 1202, receiving a MAC CE carrying a cell switch command, wherein an application time of the cell switching command is determined by one of a), b) and c) if a target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

FIG. 13 illustrates a flowchart of a method 1300 in accordance with aspects of the present disclosure. The operations of the method may be implemented by a NE as described herein. In some implementations, the NE may execute a set of instructions to control the function elements of the NE to perform the described functions.

At 1302, transmitting a MAC CE carrying a cell switch command, wherein an application time of the cell switching command is determined by one of a), b) and c) if a target cell indicated in the cell switch command is not one of the current serving cells, and is determined by d) if the target cell is one of the current serving cells:

$$a ) max \{ 3 {N}_{slot}^{subframe , μ} , {T}_{BAT} , {T}_{RRC} , {T}_{RF} \} ;$$

$$b ) 3 {N}_{slot}^{subframe , μ} + max \{ {T}_{BAT} , {T}_{RRC} , {T}_{RF} \} ;$$

$$c ) 3 {N}_{slot}^{subframe , μ} + k ;$$

$$d ) 3 {N}_{slot}^{subframe , μ} , where 3 {N}_{slot}^{subframe , μ}$$

is the regular application time for a MAC CE; T_{BAT} is beam application time; T_{RRC} is RRC updating time; and T_{RF} is RF retuning time, k is a predetermined value.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and configured to cause the UE to:
receive a transmission configuration indication (TCI) states configuration of each of one or multiple candidate cells, wherein:
the TCI states configuration includes multiple TCI states; and
each TCI state provides two different quasi-co-location (QCL) types.

2. The UE of claim 1, wherein each TCI state includes a QCL-type A synchronization signal block (SSB) and the same SSB with QCL-type D.

3. The UE of claim 1, wherein each TCI state includes a QCL-type C synchronization signal block (SSB) and the same SSB with QCL-type D.

4. The UE of claim 1, wherein each TCI state includes a QCL-type A tracking reference signal (TRS) and the same TRS with QCL-type D and the TRS is further QCLed with a SSB from the same candidate cell.

5. The UE of claim 4, wherein the at least one processor is configured to cause the UE to:
receive the TRS in a first K slots after switching to a target cell that is the candidate cell, where K>=1.

6. The UE of claim 1, wherein each TCI state is associated with a path loss reference signal (PL-RS) and/or a set of power control parameters.

7. The UE of claim 1, wherein a dedicated power control parameter set is configured for a candidate cell.

8. The UE of claim 1, wherein:
QCL-TypeD reference signal (RS) in joint TCI state is assumed as a default path loss RS (PL-RS) for the joint TCI state, and DL RS for uplink (UL) spatial transmit (Tx) filter determination in UL TCI state is assumed as the default PL-RS for the UL TCI state.

9. The UE of claim 1, wherein, after switching to a target cell, for joint TCI mode, an N^{th} activated TCI state for the target cell is mapped to an N^{th} TCI codepoint of downlink control information (DCI) format 1_1 or 1_2 of the target cell, where N is a positive integer.

10. The UE of claim 1, wherein, after switching to a target cell, for separate TCI mode, an N^{th} activated pair of TCI states for the target cell is mapped to an N^{th} TCI codepoint of downlink control information (DCI) format 1_1 or 1_2 of the target cell, where N is a positive integer.

11. The UE of claim 1, wherein the at least one processor is further configured to cause the UE to:
transmit a beam report including a L1 measurement result or a L3 measurement result, wherein, the beam report further includes an indication to indicate whether the L1 measurement result or the L3 measurement result is included in the beam report.

12. The UE of claim 1, wherein the at least one processor is configured to cause the UE to:
receive a medium access control (MAC) control element (CE) carrying a cell switch command, wherein an application time of the cell switching command is determined by one of a), b) and c) if a target cell indicated in the cell switch command is not one of current serving cells, and is determined by d) if the target cell is one of the current serving cells:
$$a ) max \{ 3 {N}_{slot}^{subframe , μ}$$
$$b ) 3 {N}_{slot}^{subframe , μ} + max \{ TBAT , TRRC , TRF \} ;$$
$$c ) 3 {N}_{slot}^{subframe , μ} + k ;$$
$$d ) 3 {N}_{slot}^{subframe , μ} , where$$
$$3 {N}_{slot}^{subframe , μ}$$
is a regular application time for a MAC CE; T_{BAT} is beam application time; T_{RRC} is RRC updating time; and T_{RF} is RF retuning time, k is a predetermined value.

13. The UE of claim 12, wherein:
the MAC CE further indicates a joint TCI state or a pair of UL TCI state and DL TCI state, and
a RS corresponding to a QCL-TypeD RS in the joint or DL TCI state is set as a beam failure detection RS after the application time of the cell switching command.

14. A processor for wireless communication, comprising:
at least one controller coupled with at least one memory and configured to cause the processor to:
receive a transmission configuration indication (TCI) states configuration of each of one or multiple candidate cells, wherein:
the TCI states configuration includes multiple TCI states, and
each TCI state provides two different quasi-co-location (QCL) types.

15. A method performed by a user equipment (UE), the method comprising:
receiving a transmission configuration indication (TCI) states configuration of each of one or multiple candidate cells, wherein,
the TCI states configuration includes multiple TCI states, and
each TCI state provides two different quasi-co-location (QCL) types.

16. A base station for wireless communication, comprising:
at least one memory; and
at least one processor coupled with the at least one memory and configured to cause the base station to:
transmit a transmission configuration indication (TCI) states configuration of each of one or multiple candidate cells, wherein:
the TCI states configuration includes multiple TCI states, and
each TCI state provides two different quasi-co-location (QCL) types.

17. The method of claim 15, wherein each TCI state includes a QCL-type A synchronization signal block (SSB) and the same SSB with QCL-type D.

18. The method of claim 15, wherein each TCI state includes a QCL-type C synchronization signal block (SSB) and the same SSB with QCL-type D.

19. The method of claim 15, wherein each TCI state includes a QCL-type A tracking reference signal (TRS) and the same TRS with QCL-type D and the TRS is further QCLed with a SSB from the same candidate cell.

20. The method of claim 19, further comprising receiving the TRS in a first K slots after switching to a target cell that is the candidate cell, where K>=1.
